(19) United States
(12) Patent Application Publication
(10) Pub. No.: US 2006/0146307 A1
(43) Pub. Date: Jul. 6, 2006

(54) Lithographic apparatus and device manufacturing method

(75) Inventors: Steven George Hansen, Phoenix, AZ (US); Doug Van Den Broeke, Sunnyvale, CA (US)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/025,602

(22) Filed: Dec. 30, 2004

(51) Int. Cl. G03B 27/54

(52) U.S. Cl. 355/67; 355/53

(57) ABSTRACT

A lithographic apparatus includes a support structure configured to hold a phase shift mask, the phase shift mask configured to pattern a beam of unpolarized radiation according to a desired pattern and a substrate table configured to hold a substrate. The lithographic apparatus also includes a projection system configured to project the patterned beam onto a target portion of the substrate on which a negative resist layer is deposited to form an image of the pattern on the negative resist layer.

### BACKGROUND

1. Field

The present invention relates to a lithographic apparatus and a method of making a device.

2. Background

A lithographic projection apparatus can be used, for example, in the manufacture of integrated circuits (ICs), patterns of circuit features, such as lines, contact holes or other elements. In such a case, a patterning device generates a circuit pattern corresponding to an individual layer of the IC, and this pattern can be imaged onto a target portion (e.g. comprising one or more dies) on a substrate (for example a silicon wafer) that has been coated with a layer of radiation sensitive material (resist). In general, a single substrate will contain a whole network of adjacent target portions that are successively irradiated via the projection system, one at a time.

The term “patterning device” as here employed should be broadly interpreted as referring to device that can be used to endow an incoming radiation beam with a patterned cross-section, corresponding to a pattern that is to be created in a target portion of the substrate. The term “light valve” can also be used in this context. Generally, the pattern will correspond to a particular functional layer in a device being created in the target portion, such as an integrated circuit or other device.

An example of such a patterning device is a mask. The concept of a mask is well known in lithography, and it includes mask types such as binary, alternating phase shift, and attenuated phase shift, chromeless phase shift masks, as well as various hybrid mask types. Placement of such a mask in the radiation beam causes selective transmission (in the case of a transmissive mask) or reflection (in the case of a reflective mask) of the radiation impinging on the mask, according to the pattern on the mask. In the case of a mask, the support structure will generally be a mask table, which ensures that the mask can be held at a desired position in the incoming radiation beam, and that it can be moved relative to the beam if so desired.

For purposes of simplicity, the rest of this text may, at certain locations, specifically direct itself to examples involving a mask and mask table. However, the general principles discussed in such instances should be seen in the broader context of the patterning device as hereabove set forth.

In current lithographic apparatus (e.g., employing patterning by a mask on a mask table) a distinction can be made between two different types of lithographic apparatus. In one type of lithographic projection apparatus, each target portion is irradiated by exposing the entire mask pattern onto the target portion at once. Such an apparatus is commonly referred to as a stepper. In an alternative apparatus, commonly referred to as a step and scan or scanner apparatus, each target portion is irradiated by progressively scanning the mask pattern under the patterned beam in a given reference direction (the “scanning” direction) while synchronously scanning the substrate table parallel or anti-parallel to this direction. Since, in general, the projection system of a lithographic apparatus will have a magnification factor M (generally<1), the speed V at which the substrate table is scanned will be a factor M times that at which the mask table is scanned. More information with regard to lithographic apparatus as here described can be seen, for example, from U.S. Pat. No. 6,046,792.

In a known manufacturing process using a lithographic projection apparatus, a pattern (e.g. in a mask) is imaged onto a substrate that is at least partially covered by a layer of radiation sensitive material (resist). Prior to this imaging, the substrate may undergo various procedures, such as priming, resist coating and a soft bake. After exposure, the substrate may be subjected to other procedures, such as a post-exposure bake (PEB), development, a hard bake and measurement and/or inspection of the imaged features. This array of procedures is used as a basis to pattern an individual layer of a device, e.g. an IC. Such a patterned layer may then undergo various processes such as etching, ion-implantation (doping), metallization, oxidation, chemical, mechanical polishing, etc., all intended to finish off an individual layer. If several layers are required, then the whole procedure, or a variant thereof, will have to be repeated for each new layer and the overlay (juxtaposition) of the various stacked layers is performed as accurately as possible. For this purpose, a small reference mark is provided at one or more positions on the substrate, thus defining the origin of a coordinate system on the substrate. Using optical and electronic devices in combination with the substrate holder positioning device (referred to hereinafter as “alignment system”), this mark can then be relocated each time a new layer has to be juxtaposed on an existing layer, and can be used as an alignment reference. Eventually, an array of devices will be present on the substrate. These devices are then separated from one another by a technique such as dicing or sawing, whence the individual devices can be mounted on a carrier, connected to pins, etc. Further information regarding such processes can be obtained, for example, from the book “Microchip Fabrication: A Practical Guide to Semiconductor Processing”, Third Edition, by Peter van Zant, McGraw Hill Publishing Co., 1997, ISBN 0-07-067250-4.

For the sake of simplicity, the projection system may hereinafter be referred to as the “lens.” However, this term should be broadly interpreted as encompassing various types of projection system, including refractive optics, reflective optics, and catadioptric systems, for example. Further, the lithographic apparatus may be of a type having two or more substrate tables (and/or two or more patterning device tables). In such “multiple stage” lithographic apparatus the additional tables may be used in parallel or preparatory steps may be carried out on one or more tables while one or more other tables are being used for exposures. Dual stage lithographic apparatus are described, for example, in U.S. Pat. Nos. 5,969,441 and 6,262,796.

Development of new apparatus and methods in lithography have lead to improvements in resolution of the imaged features, such as lines and contact holes or vias, patterned on a substrate, possibly leading to a resolution of less than 50 nm. This may be accomplished, for example, using relatively high numerical aperture (NA) projection systems (greater than 0.75 NA), wavelengths of 193 nm or less, and a plethora of techniques such as phase shift masks, non-conventional illumination and advanced photoresist processes.

However, certain features such as contact holes are especially difficult to fabricate. The success of manufacturing processes at sub-wavelength resolutions will rely on the ability to print low modulation images or the ability to increase the image modulation to a level that will give acceptable lithographic yield.

Typically, the Rayleigh criterion has been used to evaluate the critical dimension (CD) and depth of focus (DOF) capability of a lithographic process. The CD and DOF can be given by the following equations:
CD=k₁(λ/NA),
and
DOF=k₂(λ/NA²),
where λ is the wavelength of the illumination, k₁ and k₂ are constants for a specific lithographic process, and NA is the numerical aperture.

Additional measures that provide insight into the difficulties associated with lithography at the resolution limit include the Exposure Latitude (EL), the Dense:Isolated Bias (DIB), and the Mask Error Enhancement Factor (MEEF). The exposure latitude describes the percentage dose range where the printed pattern's critical dimension (CD) is within acceptable limits, for example, the exposure latitude may be defined as the change in exposure dose that causes a 10% change in printed line width. Exposure latitude is a measure of reliability in printing features in lithography. It is used along with the DOF to determine the process window, i.e., the regions of focus and exposure that keep the final resist profile within prescribed specifications. Dense:isolated bias is a measure of the size difference between similar features, depending on the pattern density. Finally, the MEEF describes how patterning device CD errors are transmitted into substrate CD errors.

Among the trends in lithography is to reduce the CD by lowering the wavelength used, increasing the numerical aperture, and/or reducing the value of k1. However, printing can be difficult in low k1 applications. For example, contact holes are difficult to print when k1 is less than 0.5. Contact holes are not only one of the smallest structures but they are also a three dimensional structure rendering the requirement on the depth of focus even more stringent. Furthermore, a high contrast image of sufficient quality that includes a plurality of contact holes, such as contact arrays, can be especially hard to print as requirements on the pitch are also increased.

### SUMMARY

According to an aspect of the present invention, there is provided a method of manufacturing a device including illuminating a phase shift mask with a beam of unpolarized radiation to produce a patterned beam of radiation and exposing a negative resist layer deposited on a substrate with the patterned beam of radiation to form an image of the pattern on the negative resist layer.

According to another aspect of the present invention, there is provided a lithographic apparatus including a support structure configured to hold a phase shift mask, the phase shift mask configured to pattern a beam of unpolarized radiation according to a desired pattern and a substrate table configured to hold a substrate. The lithographic apparatus also includes a projection system configured to project the patterned beam onto a target portion of the substrate on which a negative resist layer is deposited to form an image of the pattern on the negative resist layer.

### BRIEF DESCRIPTION OF THE DRAWINGS

These and other aspects of the invention will become more apparent and more readily appreciated from the following detailed description of the present exemplary embodiments of the invention, taken in conjunction with the accompanying drawings, of which:

FIG. 1 schematically depicts a lithographic projection apparatus according to an embodiment of the invention;

FIG. 2A is a schematic representation of a conventional binary imaging mask pattern designed for printing contact holes;

FIG. 2B is schematic representation of a conventional attenuated phase shift mask pattern designed for printing contact holes;

FIG. 3 is a schematic representation of a chromeless phase shift (CPL) mask designed for printing contact holes in accordance with an embodiment of the present invention;

FIG. 4 is a schematic representation of a conventional vortex mask designed for printing contact holes on a negative resist;

FIG. 5 is a cross-section of an example of a quadrupole illumination in accordance with an embodiment of the present invention;

FIG. 6 is a cross-section of an example of a quadrupole illumination in accordance with another embodiment of the present invention;

FIG. 7 is a cross-section of an example of a small sigma conventional illumination;

FIG. 8 shows plots of the intensity of radiation of an aerial image at best focus cut across four holes for different combinations of resists, illumination configurations and mask types in accordance with an embodiment of the present invention;

FIG. 9 is a plot showing a comparison between a normalized intensity profile obtained when using a chromeless phase shift mask in conjunction with a negative resist and an intensity profile obtained when using a vortex mask in conjunction with a negative resist in accordance with an embodiment of the present invention;

FIG. 10 shows the process window for different combinations of resists, illumination configurations and mask types in accordance with an embodiment of the present invention;

FIG. 11 shows plots of the intensity of radiation of an aerial image at best focus cut across four holes for different combinations of resists, illumination configurations and mask types in accordance with an embodiment of the present invention; and

FIG. 12 shows the process window for different combinations of resists, illumination configurations and mask types in accordance with an embodiment of the present invention.

### DETAILED DESCRIPTION

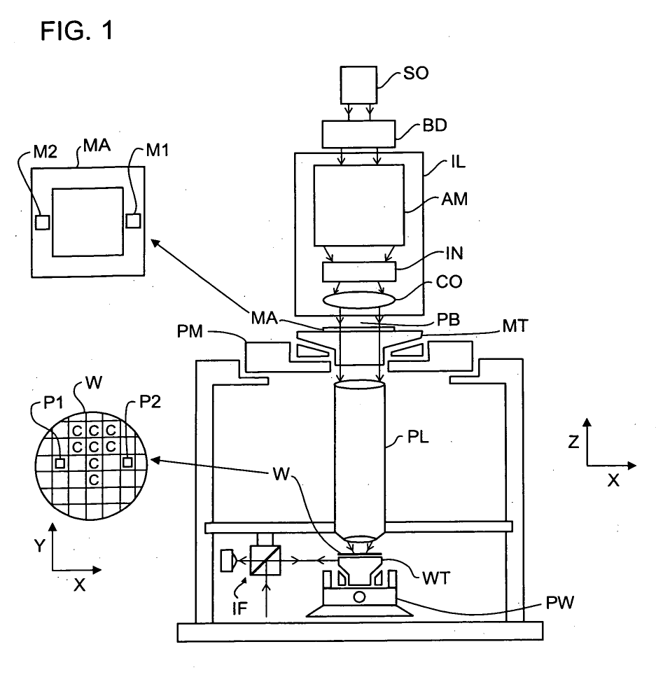

FIG. 1 schematically depicts a lithographic apparatus according to an embodiment of the invention. The apparatus comprises an illumination system (illuminator) IL adapted to condition a beam PB of radiation (e.g. UV radiation). The apparatus also comprises a support structure (e.g. a mask table) MT configured to hold a patterning device (e.g. a mask) MA and connected to a first positioning device PM configured to accurately position the patterning device with respect to item PL.

The apparatus also comprises a substrate table (e.g. a wafer table) WT configured to hold a substrate (e.g. a resist-coated wafer) W and connected to a second positioning device PW configured to accurately position the substrate with respect to item PL.

The apparatus also comprises a projection system (e.g. a refractive projection lens) PL adapted to image a pattern imparted to the beam PB by the patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise an adjusting device AM configured to adjust the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation, referred to as the projection beam PB, having a desired uniformity and intensity distribution in its cross-section.

The projection beam PB is incident on the patterning device MA, which is held on the mask table MT. Having traversed the patterning device MA, the projection beam PB passes through the projection system PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the support structure MT and substrate table WT will be realized with the aid of a long-stroke module (coarse positioning) and a short-stroke module (fine positioning), which form part of the one or both of the positioning devices PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in the following preferred modes:

1. In step mode, the support structure MT and the substrate table WT are kept essentially stationary, while an entire pattern imparted to the projection beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the projection beam is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the projection beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes a programmable patterning device, such as a programmable mirror array of a type as referred to above.

Combinations and/or variations on the above described modes of use or entirely different modes of use may also be employed.

Historically, the resolution limit of a lithographic projection apparatus was optimized by the control of the relative size of the illuminator numerical aperture (NA). Control of this NA with respect to the projection system's NA allows for modification of spatial coherence at the mask plane, commonly referred to as partial coherence a. This is accomplished through specification of the condenser lens pupil in a Köhler illumination system. Essentially, this allows for manipulation of the optical processing of diffraction information. Optimization of the partial coherence of a projection imaging system is conventionally accomplished using full circular illumination apertures. By controlling the distribution of diffraction information in the projection system with the illuminator pupil size, maximum image modulation may be obtained.

Illuminators can be further refined by considering variations to full circular illumination apertures. A system where illumination is obliquely incident on the mask at an angle so that the zeroeth and first diffraction orders are distributed on alternative sides of the optical axis may allow for improvements. Such an approach is generally referred to as off-axis illumination.

Off-axis illumination may improve resolution by illuminating the mask with radiation that is at an angle to the optical axis of the projection system. The incidence of the radiation on the mask, which acts as a diffraction grating, may improve the contrast of the image by transmitting more of the diffracted orders through the projection system. Off-axis illumination techniques used with conventional masks can produce resolution enhancement effects similar to resolution enhancement effects obtained with phase shift masks.

Various other enhancement techniques that have been developed to increase the resolution and the DOF include optical proximity correction (OPC) of optical proximity errors (OPE), phase shift masks (PSM), and sub-resolution assist features (SRAF). Each technique may be used alone, or in combination with other techniques to enhance the resolution of the lithographic projection apparatus.

Positive resist approaches to printing small contact holes or small features can be successful if a QUASAR™ illumination is used for processes in which k1 is greater than 0.35. A QUASAR illumination is a quadrupole illumination in which the four poles are oriented at a 45 degrees angle relative to the X and Y axes. However, smaller pitches require a more aggressive CQUAD™ illumination. A CQUAD illumination is a quadrupole illumination in which two illumination poles are on the Y axis and the two other illumination poles are on the Y axis.

However, in positive resist processes, a CQUAD illumination used in combination with a binary imaging mask (BIM) or an attenuated phase shift mask (AttPSM) may provide only a low dose exposure latitude and a high MEEF making these processes unsuitable for production use.

A technique that was recently proposed to lower k₁ below 0.4 is to use a vortex mask (see, e.g., M. D. Levenson et al., “The Vortex Mask: Making 80 nm Contacts with a Twist!”, 22^{nd} Annual BACUS Symposium on Photomask Technology, Proceeding of SPIE Vol. 4889 (2002)). A vortex mask is composed of rectangles with phases of 0 degrees, 90 degrees, 180 degrees and 270 degrees. The walls of the phase trenches are nearly vertical, with all four-phase regions meeting at sharp corners, which define the phase singularities. Because the phase of the wavefront is not defined at the corner where the rectangles with the four different phases meet, the intensity at that point is equal to zero in accordance with the laws of physics, i.e., the central core of the vortex must be dark. Thus, after traversing the vortex mask, the radiation wavefront spirals like a vortex and has a zero amplitude on its central core, instead of forming a plane or a sphere. In combination with a negative resist process and a low sigma illumination, the central axis dark spot of the optical vortex transferred onto the substrate may potentially produce very small contact holes with acceptable process latitude. The vortex mask technique supports larger process windows, at small k₁ values as low as 0.2, than conventional techniques. However, this technique has limitations which may include difficulties in making a vortex mask (three precise etch steps are required instead of one) and may also require the use of very low sigma illumination in order to obtain sufficient DOF.

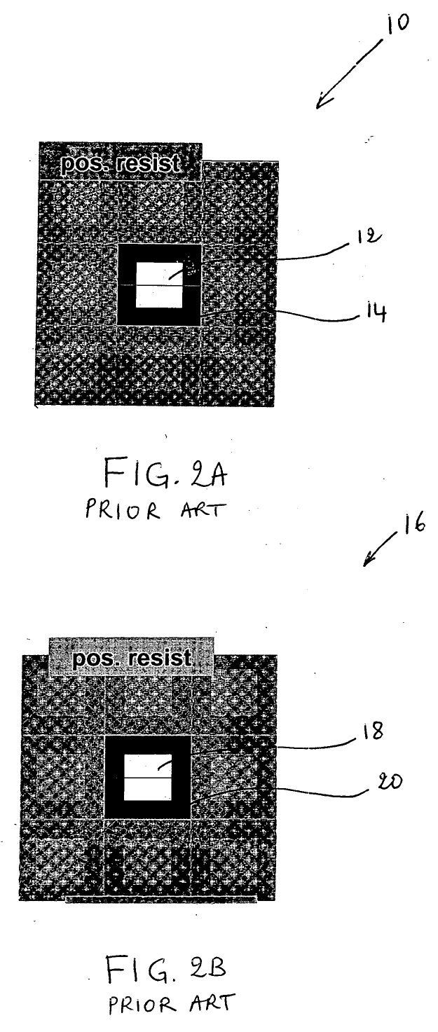

FIG. 2A is a schematic representation of a binary imaging mask pattern designed for printing contact holes on a positive resist. Binary imaging mask 10 comprises a 100% transmission region 12 and an opaque region 14. In this case, neither of the transmission region 12 and the opaque region 14 introduces a phase shift to a wavefront incident on the mask 10. The opaque region 14 surrounds the transmission region 12 thus defining a hole therein. This pattern can be repeated numerous times for printing a plurality of contact holes, shown in FIG. 2A as grayed areas.

FIG. 2B is a schematic representation of an attenuated phase shift mask pattern designed for printing contact holes on a positive resist. Attenuated phase shift mask 16 comprises a 100% transmission region 18 and a 6% transmission region (94% opaque region) 20. The 100% transmission region does not induce any phase shift to an incident radiation wavefront and the 6% transmission region provides a 180 degrees phase shift relative to the 100% transmission region. In the 6% transmission region 20, the intensity of the radiation is attenuated and only 6% of the radiation intensity is transmitted therethrough. The 6% transmission region 20 surrounds the 100% transmission region 18 thus defining a hole therein. Similarly, the pattern can be repeated numerous times for printing a plurality of contact holes, shown in FIG. 2B as grayed areas.

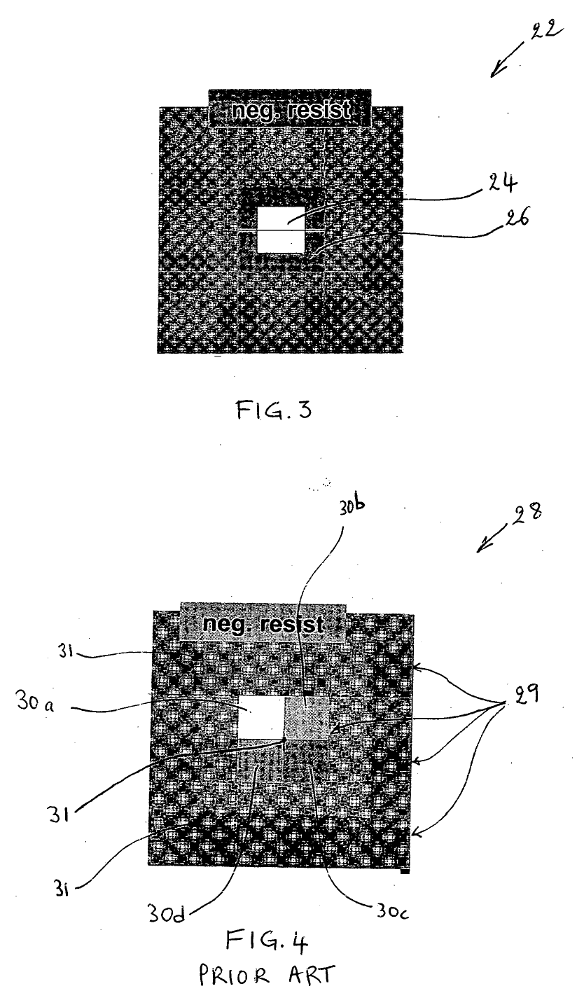

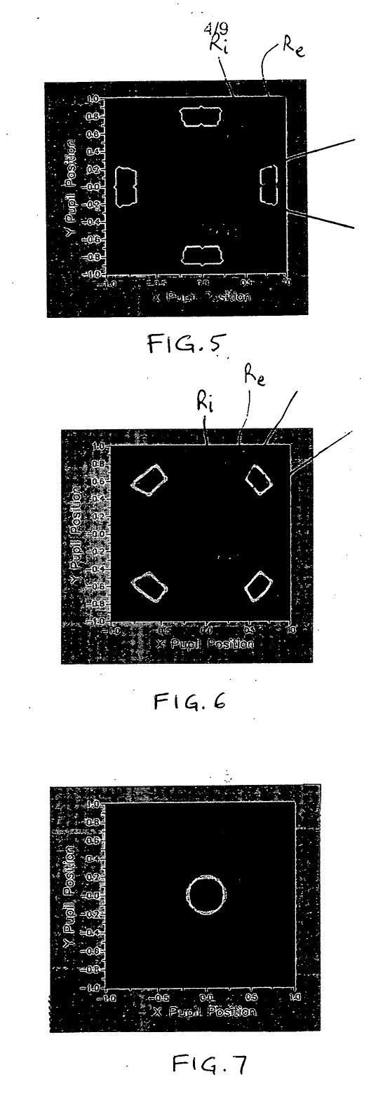

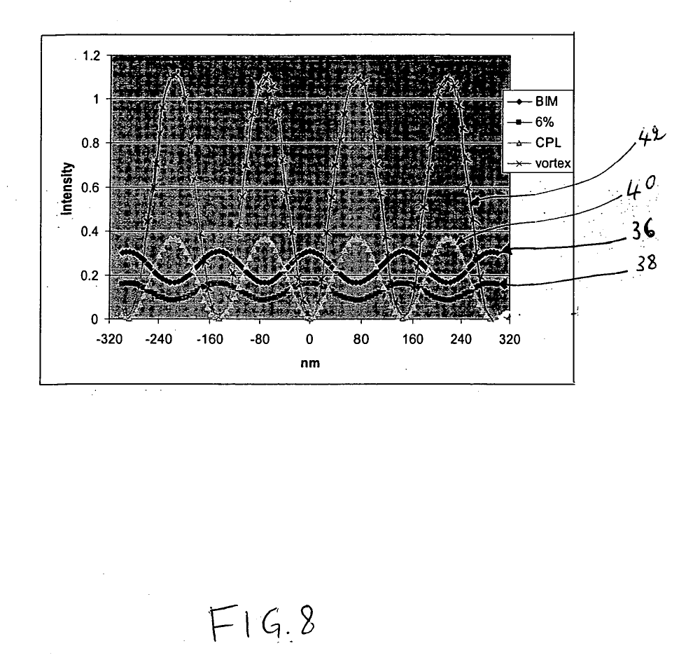

FIG. 3 is a schematic representation of a chromeless phase shift (CPL) mask designed for printing contact holes on a positive resist or a negative resist. Chromeless phase shift mask 22 comprises a 100% transmission region 24 and a 100% transmission region 26. The transmission region 24 does not induce any phase shift to an incident wavefront and the transmission region 26 provides a 180 degrees phase shift relative to the transmission region 24. The phase shifting transmission region 26 surrounds the non-phase shifting transmission region 24 thus defining a phase shift “hole” therein. Similarly, the pattern can be repeated numerous times for printing a plurality of contact holes on a positive or a negative resist, shown in FIG. 3 as grayed areas.

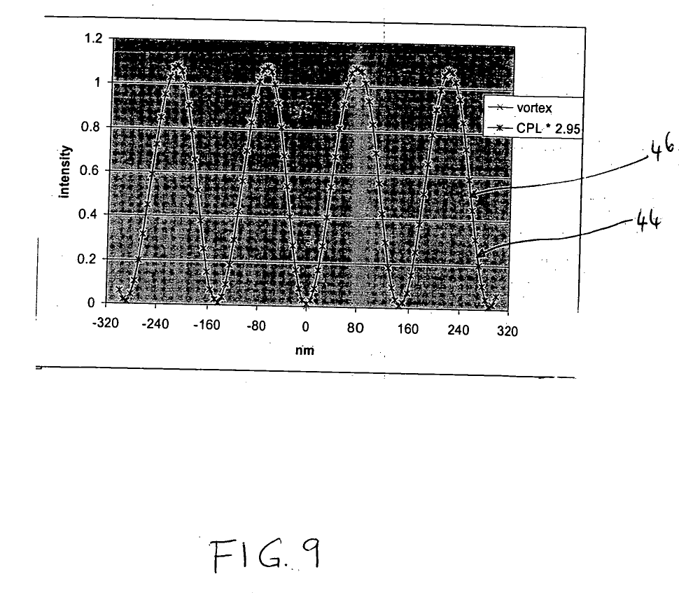

FIG. 4 is a schematic representation of a vortex mask designed for printing contact holes on a negative resist. Vortex mask 28 is composed of rectangles or squares 29. Each rectangle 29 has four-phase regions 30a, 30b, 30c and 30d. Phase regions 30a, 30b, 30c and 30d induce a phase shift of 0 degrees, 90 degrees, 180 degrees and 270 degrees, respectively, to the incident radiation wavefront. The four-phase regions 30a, 30b, 30c and 30d meet at sharp corners 31, thus defining phase singularities. As stated above, because the phase of the radiation wavefront is not defined at the corner where the regions with the four different phases meet, the intensity at that point (e.g., point 31) is equal to zero. Therefore, after impinging the mask, the radiation wavefront spirals like a vortex and has a zero amplitude at its central core. The dark spot of the optical vortex transferred onto a negative resist allows for printing of very small contact holes with high contrast.

Various approaches to printing holes are simulated with a PROLITH 8.01 vector imaging simulation tool developed by KLA-Tencor. The approaches include using off-axis quadrupole illumination with binary imaging masks (shown in FIG. 2A) and using off-axis quadrupole illumination with attenuated phase shift masks (shown in FIG. 2B) to print contact holes on a positive resist and using off-axis quadrupole illumination with a chromeless phase shift mask (shown in FIG. 3) to print contact holes on a positive or a negative resist. Examples of off-axis quadrupole illumination include a CQUAD illumination shown in FIG. 5 and a QUASAR illumination shown in FIG. 6. The off-axis quadrupole illumination can be of a polarized or an unpolarized nature. However, in the simulations presented herein, only unpolarized light is contemplated to demonstrate that the use of unpolarized illumination in combination with a judicious selection of other parameters can be powerful in printing, for example, contact holes. The approach in which polarized light is used to print on a substrate is discussed in detail in a co-pending U.S. patent application Ser. No. 10/781,803, filed on Feb. 20, 2004, entitled “Lithographic Printing with Polarized Light,” the entire contents of which are incorporated herein by reference.

Another approach to printing holes that is simulated to provide a comparative example is one in which a vortex mask (shown in FIG. 4) is used in conjunction with small sigma illumination to print contact holes on a negative resist. An example of small sigma illumination used in the simulation is shown in FIG. 7. The illumination shown in FIG. 7 is a 0.2σ illumination, meaning that the radius of the illumination spot is 0.2 (in units of NA of the projection system).

Simulations may be carried out for the above different situations where the above different mask types are used to print contact holes at low k1. In the simulations, various parameters such as the dimension of the holes, the pitch (the distance between the holes), the numerical aperture NA and the wavelength of the radiation are selected and the intensity of the aerial image at best focus is determined for each situation. The obtained results provide intensity profiles across the contact holes for different mask types as well as different illumination types for the different situations discussed above. The intensity profiles across the contact holes are plotted. This allows a visual comparison between the different approaches discussed above for printing contact holes.

In an embodiment of the invention, for example, the dimension of the holes is selected to equal 60 nm, the pitch is selected to equal 145 nm, the numerical aperture is selected to equal 0.85 and the radiation is selected to have a 193 nm wavelength so that contact holes with a k1 equal to about 0.32 can be printed. A low k1 value, for example 0.32, will typically involve the use of a CQUAD illumination shown in FIG. 5. In this example, except for a vortex mask in which a 0.2σ illumination is used, a 0.9/0.7 CQUAD 30° quadrupole illumination is used for all other situations. As shown in FIG. 5, the number 0.9 is a value of the external radius Re of an illumination edge and 0.7 is a value of the internal radius Ri of the illumination edge. The 30 degrees angle corresponds to the opening angle θ delimiting one illumination pole.

In addition, in the simulations in which a BIM mask, a 6% attenuated phase shift mask or a CPL mask is used, a bias of 20 nm is introduced between the dimension of the hole in the mask and the dimension of the hole printed on the resist. The term “bias” is a term used in lithography for a difference between the size of the feature on the mask and the printed feature on the substrate (without taking into account the size difference due to the projection system demagnification). It is common with holes that the mask opening is relatively larger than the target size. Therefore, for example, a 60 nm hole printed with a 20 nm bias implies the hole size is 80 nm on the mask.

Furthermore, in the above example, for the sake of comparison, the simulations in which a positive resist is used are run with a TOK 6063 positive resist model and the simulations in which a negative resist is used are run with a TOK 6063 positive resist model switched to negative tone. TOK 6063 is a resist manufactured by Tokyo Ohka Kogyo, Japan. Although, a TOK 6063 positive resist and a TOK 6063 positive resist switched to negative tone are used in the simulations, it must be appreciated that other positive resist and/or negative resist models can also be used.

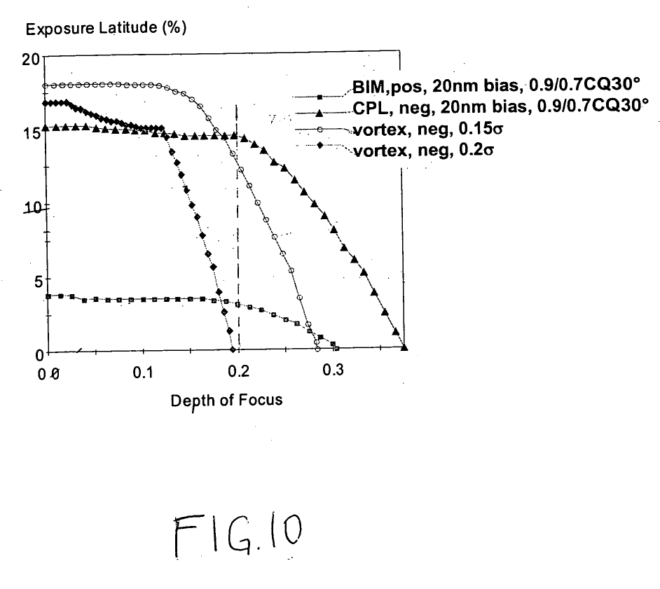

FIG. 8 shows plots of the intensity of radiation of an aerial image at best focus cut across four holes for the different situations discussed above. Curve 36 represents the intensity profile across four holes printed on a positive resist using a binary imaging mask 10 (shown in FIG. 2A). Curve 38 represents the intensity profile across four holes printed on a positive resist using the 6% attenuated phase shift mask 16 (shown in FIG. 2B). Curve 40 represents the intensity profile across four holes printed on a negative resist using a chromeless phase (CPL) mask 22 (shown in FIG. 3). Curve 42 represents the intensity profile across four holes printed on a negative resist using a vortex mask 28 (shown in FIG. 4).

From the intensity profiles plotted in FIG. 8, it can be seen that the use of a positive resist in conjunction with a binary imaging mask (BIM) and the use of a positive resist in conjunction with a 6% phase shift mask gives a poor image contrast (see intensity profiles 36 and 38). On the other hand, the use of a negative resist in conjunction with a chromeless phase (CPL) mask and the use of a negative resist in conjunction with a vortex mask provide a much better contrast (see intensity profiles 40 and 42).

In FIG. 8, the maximum intensity of intensity profile 40, i.e., when using a chromeless phase mask in conjunction with a negative resist, appears smaller than the maximum intensity of intensity profile 42, i.e., when using a vortex mask in conjunction with a negative resist. However, when normalized for intensity (by dividing the intensity data by the maximum intensity), the intensity profile obtained when using a chromeless phase mask in conjunction with a negative resist (curve 44) and the intensity profile obtained when using a vortex mask in conjunction with a negative resist (curve 46) are very similar as shown in FIG. 9. In other words, this shows that the contrast achieved when using a chromeless phase mask in conjunction with a negative resist and the contrast achieved when using a vortex mask in conjunction with a negative resist are very similar.

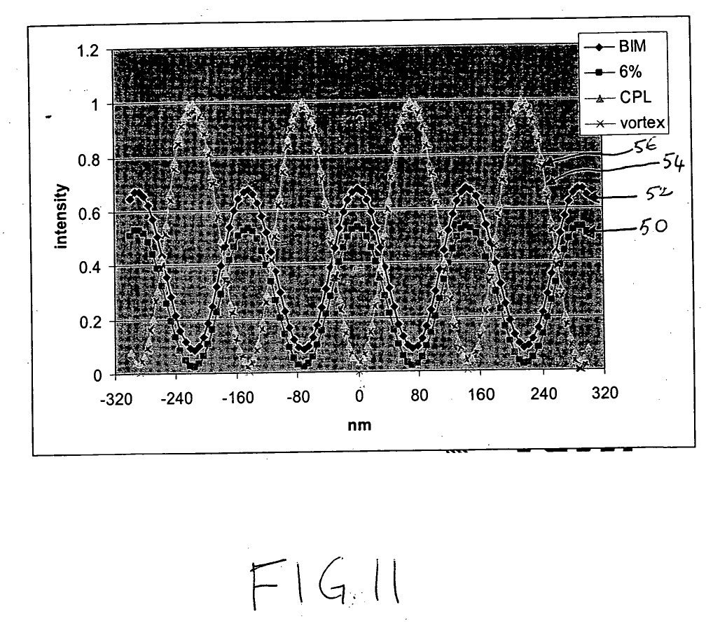

A process window comparison between the various situations is also presented. The exposure latitude versus the depth of focus is plotted for each of the situations or assumptions discussed above. FIG. 10 shows the process window for each of the situations discussed above. It can be seen that the standard positive resist process, using a positive resist in conjunction with a binary imaging mask (BIM), leads to a poor process window as the exposure latitude is low for a range of depth of focus values. Indeed, the exposure latitude in this case does not exceed 5% even at a depth of focus of 0, i.e. at the best focus.

The use of a vortex mask in conjunction with negative resist with an illumination of 0.2σ provides a much better process window. The process latitude obtained is greater than 10% in a large range of depth of focus from 0 to 0.15 and the process latitude is greater than 15% in a range of depth of focus from 0 to 0.12. When using an illumination of 0.15σ, the process latitude obtained is improved to 18% for a range of depth of focus from 0 to 0.15 and the process latitude remains greater than 15% in a range of depth of focus from 0. to 0.2. The use of a vortex mask in conjunction with a negative resist may clearly improve the process window over standard positive resist process. However, as stated above, this technique has limitations which include difficulties in making a vortex mask as well as the requirement to use a very low sigma illumination in order to obtain sufficiently broad DOF.

On the other hand, results also show that using a chromeless phase (CPL) mask in conjunction with a negative resist also achieves a good process window with a reasonable illumination condition, for example, with the use of 0.9/0.7CQUAD 30° illumination. Indeed, an exposure latitude of approximately 15% is obtained for a broad range of depth of focus from 0 to 0.2 and the exposure latitude remains greater than 10% in an even broader range of depth of focus from 0 to almost 0.3.

Furthermore, it is noted that, for example, at a depth of focus of 0.2, the exposure latitude obtained (approximately 15%) when using a CPL mask in combination with a quadrupole illumination for printing on a negative resist is greater than the exposure latitude (approximately 12.5%) obtained when using a vortex mask in combination with a 0.15σ illumination for printing on a negative resist. It is also noted that at the same depth of focus of 0.2, the exposure latitude obtained when using a vortex mask in combination with a 0.2σ illumination for printing on a negative resist is equal to 0, i.e., no exposure latitude. It is also noted that the exposure latitude obtained when using a vortex mask in combination with a small sigma illumination for printing on a negative resist decreases more rapidly with increasing depth of focus than the exposure latitude obtained when using a CPL mask in combination with a quadrupole illumination for printing on a negative resist in the 0.2 to 0.3 range of depth of focus. Furthermore, it can also be seen that at an exposure latitude of 0% or an exposure latitude of 10% a higher depth of focus is obtained when using a CPL mask in combination with a quadrupole illumination for printing on a negative resist compared to the other printing techniques.

Therefore, it is clear that overall for higher depth of focus values, the use of a CPL mask in combination with a quadrupole illumination (for example, a 0.9/0.7 CQUAD 30° illumination) and with a negative resist for printing holes (for example, 60 nm holes with a pitch of 145 nm and with a numerical aperture of 0.85 NA and a wavelength of 193 nm at a k1 of approximately 0.32) performs better than the technique of using a vortex mask with a negative resist in combination with a sigma illumination. In other words, overall a better process window is achieved with the use of a CPL mask in combination with an off-axis illumination and with the use of a negative resist.

Another set of simulations are also presented in which the wavelength of radiation is set at 157 nm. In an embodiment of the invention, for example, the dimension of the holes is selected to equal 60 nm, the pitch is selected to equal 145 nm, the numerical aperture is selected to equal 0.85 and the radiation wavelength is selected to be 157 nm so that contact holes with a k1 equal to 0.39 can be printed. In this example, except for a vortex mask in which a 0.2σ illumination is used, a 0.96/0.76 QUASAR 20° quadrupole illumination is used for all other simulations. As shown in FIG. 6, the number 0.96 is a value of the external radius Re of an illumination edge and 0.76 is a value of the internal radius Ri of the illumination edge. The 20 degrees angle corresponds to the opening angle θ delimiting one illumination pole.

In this example, a QUASAR illumination is used instead of CQUAD illumination as the QUASAR illumination can provide a better exposure latitude than the CQUAD illumination for standard positive resist approaches. However, it must be appreciated that any quadrupole illumination can be used.

FIG. 11 shows plots of the intensity of radiation of an aerial image at best focus cut across four holes for the different situations discussed above. Curve 52 represents the intensity profile across four holes printed on a positive resist using binary imaging mask 10 (shown in FIG. 2A). Curve 52 represents the intensity profile across four holes printed on a positive resist using the 6% attenuated phase shift mask 16 (shown in FIG. 2B). Curve 54 represents the intensity profile across four holes printed on a negative resist using chromeless phase (CPL) mask 22 (shown in FIG. 3). Curve 56 represents the intensity profile across four holes printed on a negative resist using vortex mask 28 (shown in FIG. 4).

From the intensity profiles plotted in FIG. 11, similarly to the results obtained previously, it can be seen that the use of a positive resist in conjunction with a binary imaging mask (BIM) and the use of a positive resist in conjunction with a 6% phase shift mask give a poor image contrast (see intensity profiles 50 and 52). On the other hand, the use of a negative resist in conjunction with a chromeless phase (CPL) mask and the use of a negative resist in conjunction with a vortex mask provide a much better contrast (see intensity profiles 54 and 56). In FIG. 11, the intensity profiles 54 and 56 are almost indistinguishable from each other as the two profiles are very similar. The use of a negative resist in conjunction with a CPL mask and the use of a negative resist in conjunction with a vortex mask provide comparable image contrasts.

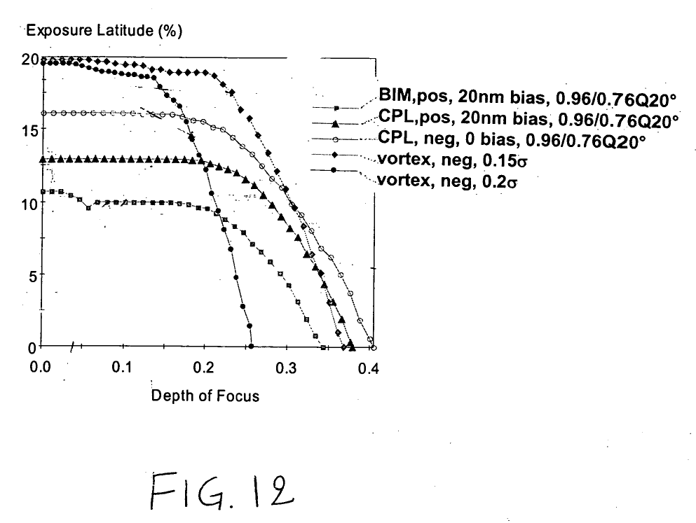

Similar to the previous analysis, a process window comparison between the various situations is also presented. The exposure latitude versus the depth of focus is plotted for each of the situations or assumptions discussed above. FIG. 12 shows the process window for each of the situation discussed above. It can be seen that the standard process using a positive resist in conjunction with a binary imaging mask (BIM), leads to a poor process window as the exposure latitude is relatively small for a range of depth of focus values. Indeed, the exposure latitude in this case does not exceed 12% even at a depth of focus of 0, i.e. at the best focus.

The use of a vortex mask in conjunction with a negative resist with an illumination of 0.2σ provides a much better process window. The process latitude obtained reaches about 20% in a range of depth of focus from 0 to 0.15. When using an illumination of 0.15σ, the process latitude obtained is slightly improved to reach about 20% for a larger range of depth of focus from 0 to 0.20. The use of a vortex mask in conjunction with a negative resist clearly improves the process window over a standard positive resist process.

On the other hand, results also show that use of chromeless phase (CPL) mask in conjunction with a positive resist may also achieve a good process window with a reasonable illumination condition, for example, with the use of 0.96/0.76 QUASAR 20° and a bias of 20 nm in the dimension of the hole. An exposure latitude of approximately 12.5% is obtained for a broad range of depth of focus from 0 to 0.2 and the exposure latitude remains greater than 10% in an even broader range of depth of focus from 0 to almost 0.3. In addition, the results also show that a use of a chromeless phase (CPL) mask in conjunction with a negative resist may further improve the process window, with the use of 0.96/0.76 QUASAR 20° illumination and a bias of 0 nm in the dimension of the hole. An exposure latitude greater than 15% is obtained for a broad range of depth of focus from 0 to 0.2 and the exposure latitude remains greater than 12.5% in an even broader range of depth of focus from 0 to almost 0.3.

Furthermore, it is noted that, for example, at a depth of focus of 0.3, the exposure latitude obtained when using a CPL mask with a negative resist and a quadrupole illumination is approximately equal to the exposure latitude obtained when using a vortex mask with a negative resist and a 0.15σ illumination. It is also noted that the exposure latitude obtained when using a vortex mask in combination with a negative resist decreases more rapidly with increasing depth of focus than the exposure latitude obtained when using a CPL mask with a negative resist in the 0.2 to 0.4 range of depth of focus.

Therefore, it is clear that overall for higher depth of focus values, e.g., in the 0.2 to 0.3 range, the use of a CPL mask in combination with a negative resist and a quadrupole illumination (for example a 0.96/0.76 QUASAR 20° illumination) for printing holes (for example, 60 nm holes with a pitch of 145 nm using a numerical aperture NA of 0.85 and a radiation wavelength of 157 nm at a k1 of approximately 0.39) may perform better than the technique of using a vortex mask with a negative resist.

Furthermore, since numerous modifications and changes will readily occur to those of skill in the art, the invention should not be limited to the exact construction and operation described herein. For example, although several examples of quadrupole illumination configurations, such as QUASAR and CQUAD illumination, are discussed herein, it must be appreciated that other illumination configurations are also contemplated. For example, illuminations having a four fold symmetry, annular illuminations or other illumination configurations approximating a quadrupole illumination may also be used.

Moreover, although several specific examples of illumination configurations, patterns (e.g. including contact holes), numerical apertures of the projection system and k1 factors are discussed herein, it must be appreciated that the present invention is not limited to the set of parameters discussed herein. For example, the normalized value of the external radius of the quadrupole illumination can be selected between 0.7 and 1 and the normalized value of the internal radius of the quadrupole illumination can be selected between 0.5 and 0.9. Similarly, it must be appreciated that the opening angle delimiting a pole of light in the quadrupole illumination can be selected between 10 and 90 degrees. In addition, it must be appreciated that the holes of the pattern may have any diameter and any pitch. In an embodiment, holes with a diameter less than or equal to 60 nm can be printed and in an embodiment a pitch between two adjacent holes of the pattern of less than or equal 145 nm can be printed. Similarly, it must be appreciated that the projection system can have a numerical aperture between 0.7 and 1.5. Furthermore, it must be appreciated that the present invention also encompasses printing a pattern on a negative resist, the pattern including features, for example contact holes, corresponding to a k1 factor of less than or equal to 0.4.

Moreover, the process, method and apparatus of the present invention, like related apparatus and processes used in the lithographic arts, tend to be complex in nature and are often practiced by empirically determining the appropriate values of the operating parameters or by conducting computer simulations to arrive at a design for a given application. Accordingly, all suitable modifications and equivalents should be considered as falling within the spirit and scope of the invention.

What is claimed is:

1. A method of manufacturing a device, comprising:
illuminating a phase shift mask having a pattern with a beam of unpolarized radiation to produce a patterned beam of radiation; and
exposing a negative resist layer deposited on the substrate with the patterned beam of radiation to form an image of the pattern on the negative resist layer.

2. The method according to claim 1, wherein the phase shift mask comprises a chromeless phase shift mask.

3. The method according to claim 1, wherein illuminating the phase shift mask comprises illuminating with a quadrupole illumination.

4. The method according to claim 3, wherein said quadrupole illumination is a QUASAR illumination.

5. The method according to claim 3, wherein said quadrupole illumination is a CQUAD illumination.

6. The method according to claim 5, wherein an external radius of the quadrupole illumination has a normalized value between 0.7 and 1.

7. The method according to claim 5, wherein an internal radius of the quadrupole illumination has a normalized value between 0.5 and 0.9.

8. The method according to claim 5, wherein an opening angle delimiting a pole of light in the quadrupole illumination is selected between 10 and 90 degrees.

9. The method according to claim 1, wherein illuminating the phase shift mask comprises illuminating with an off-axis illumination.

10. The method according to claim 1, wherein holes of the pattern have a diameter less than or equal to 60 nm.

11. The method according to claim 1, wherein a pitch between two adjacent holes of the pattern is less than or equal to 145 nm.

12. The method according to claim 1, further comprising projecting the patterned beam of radiation onto the negative resist layer using a projection system having a numerical aperture between 0.7 and 1.5.

13. The method according to claim 1, wherein the pattern formed on the negative resist includes features corresponding to a k1 factor of less than or equal to 0.4.

14. A lithographic apparatus, comprising:
a support structure configured to hold a phase shift mask, the phase shift mask configured to pattern a beam of unpolarized radiation according to a desired pattern;
a substrate table configured to hold a substrate; and
a projection system configured to project the patterned beam onto a target portion of the substrate on which a negative resist layer is deposited to form an image of the pattern on the negative resist layer.

15. The apparatus according to claim 14, wherein the phase shift mask comprises a chromeless phase shift mask.

16. The apparatus according to claim 14, further comprising an illuminator configured to shape the beam as a quadrupole illumination.

17. The apparatus according to claim 16, wherein the quadrupole illumination is a QUASAR illumination.

18. The apparatus according to claim 16, wherein the quadrupole illumination is a CQUAD illumination.

19. The apparatus according to claim 16, wherein an external radius of the quadrupole illumination has a normalized value between 0.7 and 1.

20. The method according to claim 16, wherein an internal radius of the quadrupole illumination has a normalized value between 0.5 and 0.9.

21. The apparatus according to claim 16, wherein an opening angle of a pole of light in the quadrupole illumination is selected between 10 and 90 degrees.

22. The apparatus according to claim 14, further comprising an illuminator configured to shape the beam as an off-axis illumination.

23. The apparatus according to claim 14, wherein holes of the pattern have a diameter less than or equal to 60 nm.

24. The apparatus according to claim 14, wherein a pitch between two adjacent holes of the pattern is less than or equal to 145 nm.

25. The apparatus according to claim 14, wherein said projection system has a numerical aperture between 0.7 and 1.5.

26. The apparatus according to claim 14, wherein the pattern formed on the negative resist includes features corresponding to a k1 factor of less than or equal to 0.4.
